(19) United States
(12) Patent Application Publication
(10) Pub. No.: US 2016/0045057 A1
(43) Pub. Date: Feb. 18, 2016

(54) Beverage Warming Assembly

(71) Applicant: Donald J. Gioggia, Belford, NJ (US)

(72) Inventor: Donald J. Gioggia, Belford, NJ (US)

(21) Appl. No.: 14/227,822

(22) Filed: Mar. 27, 2014

(51) Int. Cl. A47J 31/00

(52) U.S. Cl. CPC A47J 31/005

(57) ABSTRACT

A beverage warming assembly for maintaining the beverage at a preferred temperature includes a housing that is positionable in a vehicle. The housing has a top end that is open so the housing may insertably receive a container. The container contains the beverage. A heating element is operationally coupled to the housing. The heating element heats the container when the container is positioned within the housing. The beverage is warmed to the preferred temperature. An actuator is coupled to the housing. The actuator is operationally coupled to the heating element.

### BACKGROUND OF THE DISCLOSURE

### Field of the Disclosure

The disclosure relates to beverage warming devices and more particularly pertains to a new beverage warming device for maintaining the beverage at a preferred temperature.

### SUMMARY OF THE DISCLOSURE

An embodiment of the disclosure meets the needs presented above by generally comprising a housing that is positionable in a vehicle. The housing has a top end that is open so the housing may insertably receive a container. The container contains the beverage. A heating element is operationally coupled to the housing. The heating element heats the container when the container is positioned within the housing. The beverage is warmed to the preferred temperature. An actuator is coupled to the housing. The actuator is operationally coupled to the heating element.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a beverage warming assembly according to an embodiment of the disclosure.

FIG. 2 is a top perspective view of an embodiment of the disclosure.

FIG. 3 is a bottom view of an embodiment of the disclosure.

FIG. 4 is a front view of an embodiment of the disclosure.

FIG. 5 is a top view of an embodiment of the disclosure.

FIG. 6 is an in-use view of an embodiment of the disclosure.

### DESCRIPTION OF THE PREFERRED EMBODIMENT

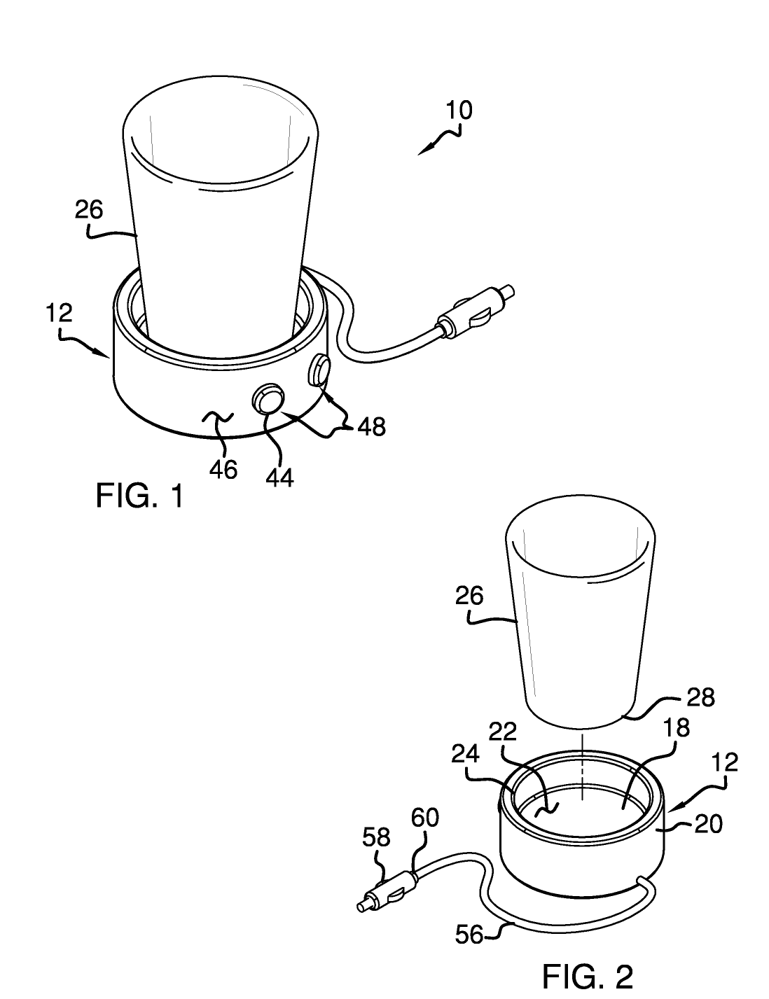

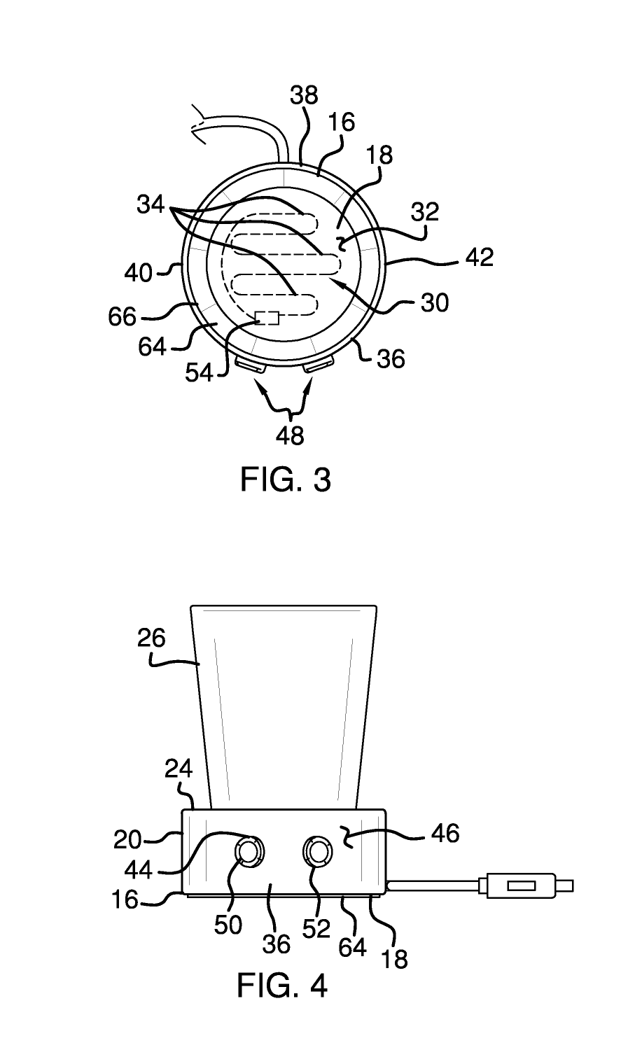

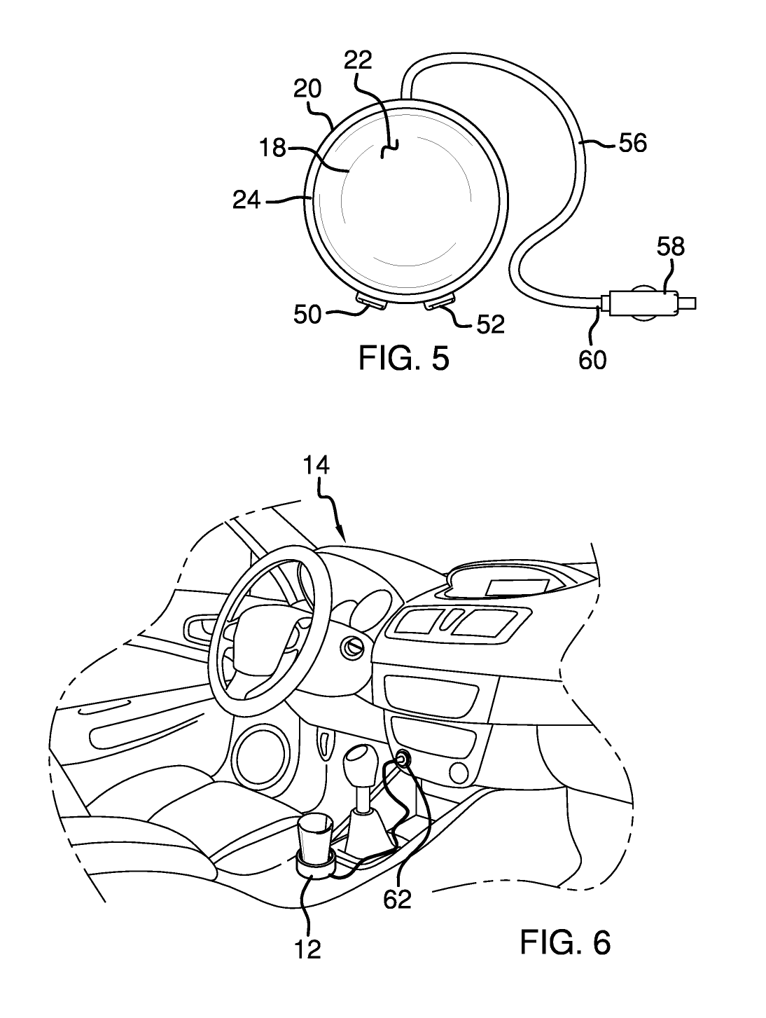

With reference now to the drawings, and in particular to FIGS. 1 through 6 thereof, a new beverage warming device embodying the principles and concepts of an embodiment of the disclosure and generally designated by the reference numeral 10 will be described.

As best illustrated in FIGS. 1 through 6, the beverage warming assembly 10 generally comprises a housing 12 that is positionable in a vehicle 14. The vehicle 14 may be a passenger vehicle of any conventional design. An outer edge 16 of a bottom wall 18 of the housing 12 is curved so the bottom wall 18 of the housing has a circular shape. Additionally, an exterior wall 20 of the housing 12 extends upwardly from a top surface 22 of the bottom wall 18 of the housing 12. The exterior wall 20 of the housing 12 is positioned proximate to and is coextensive with the outer edge 16 of the bottom wall 18 of the housing 12.

The exterior wall 20 of the housing 12 has a top end 24. The top end 24 of the exterior wall 20 of the housing 12 is open. The housing 12 may be comprised of a heat conductive material. A container 26 is removably positionable through the top end 24 of the exterior wall 20 of the housing 12 so a bottommost surface 28 of the container 26 abuts the top surface 22 of the bottom wall 18 of the housing 12. The container 26 may be a coffee cup of any conventional design and the container 26 contains a beverage. The beverage may be a hot beverage of any conventional design.

A heating element 30 is positioned between a lowermost surface 32 and the top surface 22 of the bottom wall 18 of the housing 12. The heating element 30 comprises a plurality of loops 34 that is evenly spaced apart and distributed between a front side 36 and a back side 38 of the bottom wall 18 of the housing 12. The plurality of loops 34 extends between each of a first lateral side 40 and a second lateral side 42 of the bottom wall 18 of the housing 12. Moreover, the heating element 30 heats the container 26 when the container 26 is positioned within the housing 12. The beverage is warmed to a preferred temperature. The heating element 30 may have an operational temperature between 150° Fahrenheit and 190° Fahrenheit.

A ring 64 is coupled to and extends downwardly from the lowermost surface 32 of the bottom wall 18 of the housing 12. An outside edge 66 of the ring 64 is coextensive with the outer edge 16 of the bottom wall 18 of the housing 12. The ring 64 frictionally engages the vehicle 14 when the housing 12 is positioned in the vehicle 14. The ring 64 retains the housing 12 in a selected position in the vehicle 14.

An actuator 44 is coupled to an outer surface 46 of the exterior wall 20 of the housing 12. The actuator 44 is centrally positioned on the front side 36 of the exterior wall 20 of the housing 12. Moreover, the actuator 44 is electrically coupled to the heating element 30. The actuator 44 comprises a knob that may be rotated.

The actuator 44 is one of a pair of the actuators 48 that are spaced laterally apart. A first one of the pair of actuators 50 selectively actuates and de-actuates the heating element 30. A second one of the pair of actuators 52 adjusts a temperature of the heating element 30 between a minimum and a maximum temperature.

A power supply 54 is coupled the housing 12. The power supply 54 is electrically coupled to the heating element 30. The power supply 54 may have an operational voltage between 9 VDC and 12 VDC. Additionally, the power supply 54 comprises a cord 56 extending away from the back side 38 of the exterior wall 20 of the housing 12.

A plug 58 is electrically coupled to a free end 60 of the cord 56. The plug 58 is selectively electrically coupled to the vehicle's electrical system 62. Moreover, the plug 58 may be a cigarette lighter adapter of any conventional design.

In use, the housing 12 is positioned within the vehicle 14. The first actuator 50 is actuated to an on position and the second actuator 52 s positioned to a selected temperature. The container 26 is positioned within the housing 12 so the beverage is maintained at the selected temperature. The container 26 is refilled with beverage as many times as needed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A beverage warming assembly for maintaining the beverage at a preferred temperature, said assembly comprising:
a housing being positionable in a vehicle, said housing having a top end being open such that said housing is configured to insertably receive a container, the container containing the beverage;
a heating element operationally coupled to said housing, said heating element heating the container when the container is positioned within said housing such that the beverage is warmed to the preferred temperature; and
an actuator coupled to said housing, said actuator being operationally coupled to said heating element.

2. The assembly according to claim 1, wherein an outer edge of a bottom wall of said housing being curved such that said bottom wall of said housing has a circular shape.

3. The assembly according to claim 1, wherein an exterior wall of said housing extending upwardly from a top surface of a bottom wall of said housing such that said exterior wall of said housing is positioned proximate to and is coextensive with an outer edge of said bottom wall of said housing.

4. The assembly according to claim 1, wherein an exterior wall of said housing having a top end, said top end of said exterior wall of said housing being open, the container being removably positionable through said top end of said exterior wall of said housing such that a bottommost surface of the container abuts a top surface of a bottom wall of said housing.

5. The assembly according to claim 1, wherein said heating element being positioned between a lowermost surface and a top surface of a bottom wall of said housing.

6. The assembly according to claim 1, wherein said heating element comprising a plurality of loops being evenly spaced apart and distributed between a front side and a back side of a bottom wall of said housing.

7. The assembly according to claim 6, wherein said plurality of loops extending between each of a first lateral side and a second lateral side of a bottom wall of said housing.

8. The assembly according to claim 1, wherein said actuator being coupled to an outer surface of an exterior wall of said housing, said actuator being centrally positioned on said exterior wall of said housing.

9. The assembly according to claim 1, wherein said actuator being electrically coupled to said heating element.

10. The assembly according to claim 1, wherein said actuator being one of a pair of said actuators.

11. The assembly according to claim 10, wherein:
a first one of said pair of actuators selectively actuating and de-actuating said heating element; and
a second one of said pair of actuators adjusting a temperature of said heating element between a minimum and a maximum temperature.

12. The assembly according to claim 1, wherein a power supply coupled said housing.

13. The assembly according to claim 12, wherein said power supply being electrically coupled to said heating element.

14. The assembly according to claim 13, wherein said power supply comprising a cord extending away from an exterior wall of said housing.

16. The assembly according to claim 14, wherein a plug electrically coupled to a free end of said cord, said plug being selectively electrically coupled to a vehicle electrical system.

17. A beverage warming assembly for maintaining the beverage at a preferred temperature, said assembly comprising:
a housing being positionable in a vehicle, an outer edge of a bottom wall of said housing being curved such that said bottom wall of said housing has a circular shape, an exterior wall of said housing extending upwardly from a top surface of said bottom wall of said housing such that said exterior wall of said housing is positioned proximate to and is coextensive with said outer edge of said bottom wall of said housing, said exterior wall of said housing having a top end, said top end of said exterior wall of said housing being open, a container being removably positionable through said top end of said exterior wall of said housing such that a bottommost surface of the container abuts said top surface of said bottom wall of said housing, the container containing the beverage;
a heating element positioned between a lowermost surface and said top surface of said bottom wall of said housing, said heating element comprising a plurality of loops being evenly spaced apart and distributed between a front side and a back side of said bottom wall of said housing, said plurality of loops extending between each of a first lateral side and a second lateral side of said bottom wall of said housing, said heating element heating the container when the container is positioned within said housing such that the beverage is warmed to the preferred temperature;
an actuator coupled to an outer surface of said exterior wall of said housing, said actuator being centrally positioned on said exterior wall of said housing, said actuator being electrically coupled to said heating element;
said actuator being one of a pair of said actuators;
a first one of said pair of actuators selectively actuating and de-actuating said heating element, a second one of said pair of actuators adjusting a temperature of said heating element between a minimum and a maximum temperature;
a power supply coupled said housing, said power supply being electrically coupled to said heating element, said power supply comprising a cord extending away from said exterior wall of said housing; and
a plug electrically coupled to a free end of said cord, said plug being selectively electrically coupled to the vehicle's electrical system.
